(19) United States
(12) Patent Application Publication
(10) Pub. No.: US 2007/0036989 A1
(43) Pub. Date: Feb. 15, 2007

(54) Low shading coefficient and low emissivity coatings and coated articles

(75) Inventors: Paul A. Medwick, Monroeville, PA (US); Russell C. Criss, Pittsburgh, PA (US); Mehran Arbab, Allison Park, PA (US); James J. Finley, Pittsburgh, PA (US); Denvra Criss, Pittsburgh, PA (US)

Correspondence Address: Andrew C. Siminerio;PPG Industries, Inc., 39th Floor, One PPG Place, Pittsburgh, PA, 15272, US

(73) Assignee: PPG Industries Ohio, Inc.

(21) Appl. No.: 11/496,734

(22) Filed: Jul. 31, 2006

Related U.S. Application Data
(63) Continuation of application No. 09/714,166, filed on Nov. 17, 2000, now abandoned.
(60) Provisional application No. 60/167,386, filed on Nov. 24, 1999.

(51) Int. Cl. B32B 17/06

(52) U.S. Cl. 428/432; 428/426; 428/689; 428/697; 428/698; 428/699; 428/701; 428/702; 428/704; 427/164; 427/165

(57) ABSTRACT

The present invention is directed to a low emissivity, low shading coefficient, low reflectance multi-layer coating and coated article having a visible light transmittance of greater than about 50%, preferably greater than about 55%, a shading coefficient of less than about 0.33 and en exterior reflectance of less than about 30%. The coated article, e.g. an IG unit, has a substrate with a first antireflective layer deposited over the substrate. A first infrared reflective layer is deposited over the first antireflective layer and a first primer layer is deposited over the first infrared reflective layer. A second antireflective layer is deposited over the first primer layer and a second infrared reflective layer is deposited over the second antireflective layer. A second primer layer is deposited over the second infrared reflective layer and a third antireflective layer is deposited over the second primer layer, such that the coated article has a transmittance greater than about 55%, a shading coefficient of less than about 0.33 and a reflectance of less than about 30%. A protective overcoat, e.g. an oxide or oxynitride of titanium or silicon, and/or solvent soluble organic film former may be deposited over the third antireflective layer.

### CROSS-REFERENCE TO RELATED APPLICATION

This application claims the benefits of U.S. Provisional Application No. 60/167,386, filed Nov. 24, 1999, entitled “LOW SHADING COEFFICIENT AND LOW EMISSIVITY COATINGS AND COATED ARTICLES”, which is herein incorporated by reference.

### FIELD OF THE INVENTION

This invention relates generally to heat-reflective and solar-control glazing materials such as multilayered coatings and to articles, e.g. windows or insulating glass units, incorporating such coatings and, more particularly, to solar-control metal oxide-containing coatings which may form solar-control articles having intermediate levels of luminous (visible light) transmittance, relatively low shading coefficient and emissivity, and acceptable levels of luminous (visible light) reflectance.

### DISCUSSION OF TECHNICAL CONSIDERATIONS

In the design of buildings, architects are sometimes asked to incorporate large amounts of windows into the building design to increase the feeling of openness and light and/or to achieve a particular exterior aesthetic. However, windows are a major source of energy transfer either into or out of a building's interior. Energy transfer across a window glazing comprises: (1) heat flow into or out of a building due to a difference between indoor and outdoor temperatures, and (2) energy transfer into a building due to solar energy transmitted and/or absorbed by the window glazing. The type of glazing that is optimal for any climate depends upon what energy transfer mechanisms have the most impact on the heating and/or cooling costs of the building and the respective lengths of the cooling and heating seasons in that geographic location.

Energy transfer due to the indoor-outdoor temperature difference is further subdivided into three different transport mechanisms: (a) conduction through the glazing and its gas contents, (b) convection associated with the movement of gases (e.g. air) at all surfaces of the glazing, and (c) thermal radiation from the surfaces of the various glazing materials. In order to reduce energy transfer across window glazings, multi-pane insulating glass (IG) units have been developed. Such multi-pane IG units inhibit energy transfer via conduction and convection pathways by creating an insulating gas pocket. However, the instant invention is most germane to energy transfer caused by thermal radiation and direct solar heat gain. Hereinafter, we therefore direct our discussion of energy transfer mostly to thermal radiation and direct solar heat gain rather than that due to conduction or convection. Of course the latter two energy transfer pathways should always be considered in building glazing design.

Considering thermal radiation and direct solar heat gain, mainly in warm climates, energy enters into the building through the window glazing via several energy mechanisms. These include: (1) long-wave thermal infrared (IR) energy (i.e. heat) radiated from hot exterior surfaces such as pavement and buildings, and (2) the shorter wavelength ultraviolet, visible, and near infrared (or “solar infrared”) radiation from the sun. The first is due to the fact that the outdoor temperature is higher than the indoor temperature. The second is either directly transmitted through the window or is first absorbed by the window glazing materials and then partially re-radiated into the interior space of the building. It is relevant to note that nearly all of the incident solar energy at the earth's surface falls almost approximately equally within the visible and solar infrared portions of the spectrum with a much smaller portion falling in the ultraviolet. The heat load contribution from the solar ultraviolet is much less than the amount of energy in the visible and solar infrared.

In cold climates, interior heat is lost through the windows thereby increasing the energy costs required to maintain a desired interior temperature. This loss is because the indoor temperature is higher than the outdoor temperature. In the case of cold climates, the heat loss due to the indoor-outdoor temperature difference is partially offset by the desirable passive solar heating of the interior space during daylight hours.

Radiative energy loss from a surface is governed by the surface's emissivity. Emissivity relates to the propensity of the surface to radiate energy. For surfaces near room temperature, this radiated energy falls within the long-wavelength thermal infrared portion of the electromagnetic spectrum. High-emissivity surfaces are good thermal radiators; a blackbody is a perfect radiator and is defined as having an emissivity of unity (e=1). In comparison, uncoated clear float glass has an emissivity of about 0.84, which is only around 16 percent less than a black body.

Radiative energy transfer across a window glazing can be inhibited by reducing the emissivity of one or more surfaces of the glass. This emissivity reduction can be realized by the use of so-called “low emissivity” or “low-E” coatings applied to the glass surface(s). Low emissivity coated glasses are attractive for architectural windows since they significantly reduce the costs of heating a building in cold climates. These low-E coatings typically comprise multilayer thin film optical stacks. The optical stacks are designed to have high reflectance in the long-wavelength thermal infrared thereby inhibiting heat transfer due to radiation across the glazing whilst retaining a high level of luminous transmittance and low luminous reflectance in the shorter-wavelength visible portion of the spectrum. In this manner the coated glass does not dramatically depart from the visual appearance of an uncoated pane of glass. Such coatings are typically referred to as “high-T/low-E” coatings. Over the past twenty years, the use of such spectrally-selective high-T/low-E coated glasses has achieved widespread marketplace acceptance in cool climates. In these climates the heating seasons are long and the passive solar heating achieved through the use of such high luminous transmittance coatings assists in counteracting heat loss due to indoor-outdoor temperature differences. One main type of such high-T/low-E coatings comprise one or more infrared-reflective layers (typically noble metals such as silver) sandwiched between dielectric layers (typically metal oxides or certain metal nitrides). Examples of low emissivity coatings are found, for example, in U.S. Pat. Nos. 5,821,001; 5,028,759; 5,059,295; 4,948,677; 4,898,789; 4,898,790; and 4,806,220, which are herein incorporated by reference.

However, because conventional high-T/low-E windows generally transmit a relatively high percentage of visible light, and solar infrared (“near infrared”) radiation to a somewhat lesser degree, use of such coatings can result in increased heat load to a building's interior in the summer season, thus increasing cooling costs. Although this problem is important for all types of buildings (such as residential homes) in warm climates, it is particularly acute for so-called “commercial” architecture; that is, buildings that house office space or other facilities primarily intended for the purposes of business and commerce like office towers, business parks, high-rise hotels, hospitals, stadiums, and tourist attractions. Conventional high-T/low-E coated glasses do impart some degree of heat load reduction in hot climates because the low-E coating reduces the thermal infrared load from hot exterior surfaces into the building's interior. However they do not shade the building's interior as effectively from directly transmitted and absorbed solar energy.

As a point of terminology, the ability of a window glazing to shade the interior space from transmitted and absorbed solar energy is characterized by a parameter known as the glazing's “shading coefficient” (hereinafter referred to as “SC”). The term “shading coefficient” is an accepted term in the field of architecture. It relates the heat gain obtained when an environment is exposed to solar radiation through a given area of opening or glazing to the heat gain obtained through the same area of ⅛ inch (3 mm) thick single-pane clear uncoated soda lime silicate glass under the same design conditions (ASHRAE Standard Calculation Method). The ⅛ inch thick clear glass glazing is assigned a shading coefficient of SC=1.00. A shading coefficient value below 1.00 indicates better heat rejection than single-pane clear glass. A value above 1.00 would be worse than the baseline clear single pane glazing.

Conventional silver-based high-T/low-E coated glasses, briefly described above, typically have SCs of about 0.44 to about 0.70 and luminous (visible) light transmittance of about 71% to about 75%. All of these values are referenced to a double-glazed IG unit installation having clear glass substrates. With such SCs, conventional high-T/low-E coated glasses are less optimal for hot climates.

What is needed and desirable, for at least hot climates as an object of the present invention are coatings to give transparency articles like window glazings (1) low-emissivity to inhibit heat ingress from the hot exterior via thermal radiation and, (2) low transmittance and/or low absorbance of direct solar radiation through the glazing. This should be accomplished while maintaining acceptable visible light transmission through the glazing.

### SUMMARY OF THE INVENTION

The present invention is directed to a low emissivity, low shading coefficient, low reflectance multi-layer coating and coated article. The coating provides a coated article of a transparent or at least translucent substrate with a surface comprising the coating of: at least one antireflective layer deposited over a substrate surface; and at least one infrared reflective layer deposited over the at least one antireflective layer, such that the coated article comprises a visible light transmittance of greater than about 50%, a shading coefficient of less than about 0.33 and a luminous exterior and/or interior reflectance of less than about 30%. The coated article, e.g. an IG unit, also preferably has a substantially neutral color in reflectance and a blue or blue-gray color in transmission. The latter value is based or measured for a double-glazed IG unit employing clear glass substrates.

The multi-layer coating of the present invention is a middle-T/low-SC/low-E coating as opposed to a high-T/low-E type coating for transparencies. The “T” refers to luminous (visible) light transmittance and the “E” refers to emissivity. The middle-T is generally in the range of greater than about 50% and suitably about 50% to about 70%. The coating is comprised of several primary layers that may be comprised of one or more films. These primary layers can be a first antireflective layer, a first infrared reflective layer, a first primer layer, second antireflective layer, second infrared reflective layer, second primer layer, and a third antireflective layer. Optionally the one or more protective overcoats can be present. These layers are arranged predominantly in the order stated one on top of the other over a substantial portion if not all of one or more surfaces of the substrate. Any portion of the surface of the substrate can be coated. Suitably when at least one surface of the substrate that is exposed to light is coated, increased benefits from the invention are realized. The aforementioned layers of the inventive coating are primary layers in that other films or layers can be between the layers themselves or the stacks of the layers as long as these secondary layers or films do not interfere with the functioning of the primary layers.

The thickness of the layers of the coating is such that the individual infrared reflective layers are not increased to be greater than that for high-T/low-E coatings. Increasing the thickness of the infrared reflective layer like silver layer(s) much beyond that for high T/low E coatings both increases the long-wavelength thermal infrared reflectivity and increases the shorter-wavelength solar infrared reflectivity. Even though the latter lowers the shading coefficient, the former reduces emissivity. Also in regards to the spectral characteristics of the infrared reflective layers, like silver thin films, simply increasing the thickness of the silver layer or film will simultaneously tend to increase the coating's reflectance and decrease the coating's transmittance in the visible region of the electromagnetic spectrum. This is an important aesthetic issue concerning the variation of reflected and transmitted colors of the coated article with the angle of observation. Such thicker silver layer(s) will tend to produce coatings that acquire reflected colors having unacceptable red or pink or orange components viewed either at normal incidence or at an oblique (grazing) angle.

Also in the present invention the thickness of the individual antireflective layers adjacent to the infrared reflective layers are not offset to some extent to compensate for any increased visible reflectance and decreased visible transmittance from any such increased thickness of the infrared reflective layers. Such modification of the physical (and therefore optical) thickness of the adjacent dielectric layers (antireflective layer) to anti-reflect the silver layer(s) in the visible and to adjust the transmitted and reflected color of the coated article is possible. Although an improvement may be viewed at normal incidence, the reflected color viewed at oblique incidence may remain objectionable, or vice versa. However, the optical characteristics of real thin film dielectric materials impose constraints on the efficacy of such an anti-reflection approach.

The coated article of the present invention is a transparent or translucent substrate usually with two major surfaces as in the form of a flat, contoured, or curved sheet with the aforementioned coating on at least one of the surfaces. Also an embodiment of the present invention is an insulated glass unit (hereinafter referred to as “IG-unit”). In the IG-unit at least two transparent substrates are sealed together with a space or gap between them generally for transparent insulating materials usually of a gaseous nature. The IG-unit can have any surface of the substrate with the aforementioned coating but suitable surfaces are either or both of the interior surfaces of the IG-unit. Also the coating could be arranged on one or more polymeric films or foils that is placed in the gap in the IG-unit. When the coating is disposed on the surface of the transparent substrate in an IG-unit the coating can be on at least one of the surfaces but preferably is on one of the surfaces facing the gap. The substrates in the IG-unit can be clear or tined or colored transparent or translucent glass or plastic. For instance the coating can be on one of the interior surfaces of a substrate in the IG-unit which is clear or colored or tinted and the other substrate without the coating can be tinted or colored glass or plastic rather than clear or untinted or uncolored.

The present invention accounts for the interdependence of solar performance, emissivity, and normal/oblique aesthetics, and in view of the limitations of real thin film optical materials, meets the challenge of producing a low-emissivity, solar-control coating having acceptable aesthetics. Such an article with such a coating can maintain acceptable aesthetics for transparencies for architectural, automotive, aerospace, or other such applications.

### BRIEF DESCRIPTION OF THE DRAWINGS

FIG. 1 is a cross-sectional view, not to scale, of a coating incorporating features of the invention; and

FIG. 2 is a cross-sectional view of an IG unit incorporating features of the invention.

### DESCRIPTION OF THE INVENTION

For purposes of the following discussion, the phrase “deposited over” means deposited above but not necessarily adjacent to. Additionally, directional terms such as “left”, “right”, “inner”, “outer”, “upper”, “lower”, etc., and similar terms shall relate to the invention as it is shown in the drawing figures. However, it is to be understood that the invention may assume various alternative orientations. Hence, such terms are not to be considered as limiting. Also, the terms “coating” or “coating stack” include one or more coating layers and/or coating films. The terms “coating layer” or “layer” include one or more coating films. Also patents and published patent documents listed in this disclosure are hereby incorporated by reference in total and specifically for that which the patents are noted as teaching. Additionally in the following discussion the numerical ranges or values for the percentage of materials and for the thickness of all of the individual layers and films and coatings are approximate and may vary slightly below the lower limit and above the upper limit or around the specifically stated number as though preceded by the word “about” for each.

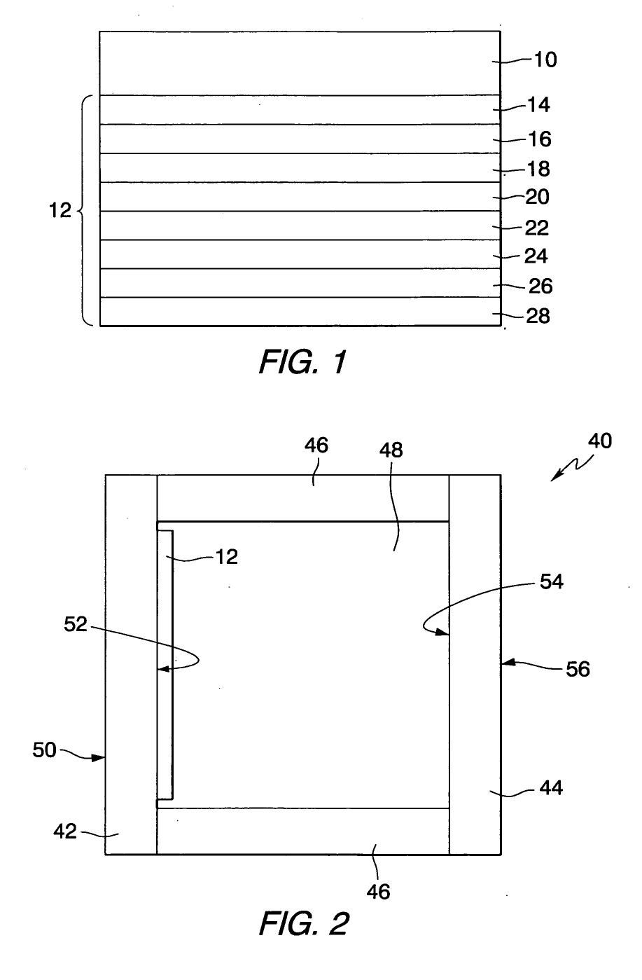

A substrate 10 having a low emissivity, low shading coefficient coating 12 incorporating features of the invention is generally shown in FIG. 1. The substrate 10 may be of any material but in the practice of the invention is preferably a transparent substrate, such as glass, plastic or ceramic. However, tinted or colored substrates may also be used. In the following discussion, the substrate 10 is preferably glass. Examples of glass suitable for the practice of the invention are described, for example, in U.S. Pat. Nos. 4,746,347; 4,792,536; 5,240,886; 5,385,872; and 5,393,593.

The coating 12 is a multilayer coating and is deposited over at least a portion of the substrate surface in conventional manner. For example, the coating 12 may be applied by magnetic sputter vapor deposition (MSVD), chemical vapor deposition (CVD), spray pyrolysis, sol-gel, etc. In the currently preferred practice of the invention, the coating 12 is applied by MSVD. MSVD coating techniques are well known to one of ordinary skill in the glass coating art and hence will not be discussed in detail. Examples of MSVD coating methods are found, for example but not to be considered as limiting, in U.S. Pat. Nos. 5,028,759; 4,898,789; 4,948,677; 4,834,857; 4,898,790; and 4,806,220.

The coating 12 includes a base layer or first antireflective layer 14 deposited over at least a portion of one of the substrate surfaces. The first antireflective layer 14 preferably comprises one or more films of dielectric materials or antireflective materials such as metal oxides or oxides of metal alloys which are preferably transparent or substantially transparent. Examples of suitable metal oxides include oxides of titanium, hafnium, zirconium, niobium, zinc, bismuth, lead, indium and tin and mixtures of any or all of these. These metal oxides may have small amounts of other materials, such as manganese in bismuth oxide, indium in tin oxide, etc. Additionally, oxides of metal alloys, such as zinc stannate or oxides of indium-tin alloys can be used. Further, doped metal oxides, such as antimony-, fluorine- or indium-doped tin oxides or mixture thereof can be used. In the practice of the invention, the first antireflective layer 14 preferably comprises one or more oxides of zinc and tin. The first antireflective layer 14 may be a substantially single phase film such as zinc stannate or may be a mixture of phases composed of zinc and tin oxides or may be composed of a plurality of metal oxide films, such as those disclosed in U.S. Pat. No. 5,821,001. Preferably, the first antireflective layer 14 comprises one or more oxides of zinc and tin, e.g. zinc stannate. The first antireflective layer 14 preferably has a thickness in the range of 272 to 332 Angstroms, more preferably around 293 Angstroms. In a currently preferred embodiment of the invention, the first antireflective layer 14 is a multifilm structure as disclosed in U.S. Pat. No. 5,821,001 having a zinc stannate film deposited over the substrate surface and a zinc oxide film deposited over the zinc stannate film. The zinc stannate film is sputtered using a zinc-tin cathode which is 52 wt % zinc and 48 wt % tin. The zinc oxide film is deposited from a zinc cathode having 10 wt % or less of tin. The zinc oxide film has a preferred thickness of 20 to 70 Angstroms in the layer as disclosed in U.S. Pat. No. 5,821,001. It is also possible that the zinc oxide film may be less than this thickness or may be omitted entirely thereby rendering the first antireflective layer 14 a single zinc stannate film.

A first IR reflective layer 16 is deposited over the first antireflective layer 14. The first IR reflective layer 16 is preferably an IR reflective metal, such as gold, platinum, copper, silver, or alloys or mixtures of any or all of these that are IR reflective. In the preferred embodiment of the invention, the first IR reflective layer 16 comprises silver and preferably has a thickness in the range of 80 to 269 Angstroms, more preferably 86 Angstroms.

A first primer layer 18 which is preferably at least one film is deposited over the first IR reflective layer 16. The first primer layer 18 is a material and deposited at such a thickness to minimize exposure of the silver layer to reaction from a subsequently applied reactive plasma for film or layer deposition. Preferably the primer layer is at least one oxygen capturing film, such as titanium, that is sacrificial during the deposition process to prevent degradation of the first IR reflective layer 16 during the sputtering process. The first primer layer 18 preferably has a thickness of 8 to 30 Angstroms, most preferably 8 to 20 Angstroms as disclosed in U.S. Pat. No. 5,821,001. For tempering of glass, the thickness of the primer layer can be increased and the thickness of the other layers can be altered to match or exceed the aesthetics and/or performance of the untempered glass.

A second antireflective layer 20 is deposited over the first primer film 18. The second antireflective layer 20 preferably comprises one or more metal oxide or metal alloy oxide films, such as those described above with respect to the first antireflective layer 14. In the currently preferred practice of the invention, the second antireflective layer 20 has a first film of zinc oxide deposited over the first primer film 18. A zinc stannate film is deposited over the first zinc oxide film and a second zinc oxide film is deposited over the zinc stannate film to form a multi-film antireflective layer. Each zinc oxide film of the second antireflective layer 20 is preferably 20 to 70 Angstroms thick, although the zinc oxide film may be less than this thickness. The second antireflective layer 20 preferably has a total thickness of 698 to 863 Angstroms, more preferably 719 Angstroms.

A second IR reflective layer 22 is deposited over the second antireflective layer 20. The second IR reflective layer 22 is preferably silver and most preferably a silver film although any of the materials listed for the first IR reflective layer 16 and has a thickness of 159-257 Angstroms, more preferably 170 to 180 Angstroms.

A second primer layer 24 is deposited over the second IR reflective layer 22. The second primer layer 24 is preferably titanium having a thickness of 8-20 Angstroms.

A third antireflective layer 26 is deposited over the second primer layer 24. The third antireflective layer 26 is also preferably one or more metal oxide or metal alloy oxide containing films such as discussed above with respect to the first antireflective layer 14. In practice, the third antireflective layer 26 includes a zinc oxide film of 20 to 70 Angstroms deposited over the second primer layer 24 as disclosed in U.S. Pat. No. 5,821,001. However the zinc oxide film may be less than this thickness or may be omitted entirely and a zinc stannate film can be deposited over this zinc oxide film. The third antireflective layer 26 has a total thickness of 60-273 Angstroms, preferably 115 Angstroms.

A protective overcoat 28 is deposited over the third antireflective layer 26 to provide protection against mechanical and chemical attack. The protective overcoat 28 is preferably an oxide of titanium like titanium dioxide having a thickness of 30-45 Angstroms. Alternatively or in addition thereto, a protective coating, such as one or more oxides or oxynitrides of silicon or one or more oxides of aluminum or mixtures or combinations of any of these, may be deposited over the titanium dioxide coating or in lieu thereof. Examples of suitable protective coatings are disclosed, for example, in U.S. patent application Ser. No. 09/058,440 and in U.S. Pat. Nos. 4,716,086; 4,786,563; 4,861,669; 4,938,857; and 4,920,006 and Canadian Application No. CA 2,156,571. In lieu of or in addition to the protective overcoat 28, temporary or removable protective films, layers or coatings can be used such as solvent soluble organic coatings like those describe in U.S. patent application Ser. No. 09/567,934, filed 10 May 2000, and similar to PCT application number WO US00/17326 filed 23 Jun. 2000. Some of these temporary protective coatings comprise: a water-soluble or water-dispersible film-forming, e.g., polymeric, material comprising one or more homopolymers or copolymers of starches, casein, and related polymers derived from proteins, acrylic polymers, polyacrylamide, polyalkylene oxide polymers such as ethylene oxide, polyvinyl acetate, polyvinyl alcohol, polyvinyl pyrrolidine, styrene/acrylic acid copolymers, ethylene/acrylic acid copolymers, cellulosics and derivatives of cellulose such as, but not limited to, methyl cellulose, hydroxy propyl methyl cellulose, carboxymethylcellulose, ethylcellulose, alkyl hydroxyalkylcellulose, and derivatives, chemical modifications, combinations, blends, alloys and/or mixtures thereof. The polyvinyl alcohol preferably has a degree of hydrolyzation of greater than about 80%, preferably greater than about 85%. Suitable polyvinyl alcohol polymers for the practice of the invention are commercially available from Air Products and Chemicals, Inc. of Allentown, Pa., as AIRVOL® 203, and 203S, polyvinyl alcohol powder or AIRVOL 24-203 aqueous polyvinyl alcohol solution (24 weight %) or dilutions thereof.

FIG. 2 depicts an IG unit 40 incorporating features of the invention. The basic structure of an IG unit is described, for example, in U.S. Pat. No. 4,902,081. The IG unit 40 includes a pair of spaced-apart first and second transparent or semitransparent supports or substrates, such as first and second glass pieces 42 and 44, separated by one or more spacers 46. The glass pieces 42 and 44 and spacers 46 are sealed to form an interior gap or chamber 48 which may be filled with a selected atmosphere, such as argon or air. For purposes of the following discussion, the left glass piece 42 will be considered the exterior or outwardly facing side of the IG unit 40 and the right glass piece 44 will be considered the interior or inwardly facing side of the IG unit 40. The left glass piece 42 has an outer surface 50 and an inner surface 52. Similarly, the interior glass piece 44 has an outwardly facing or outer surface 54 and an inwardly facing or inner surface 56. The multi-layer coating 12 of the invention is preferably deposited either on the inner surface 52 of the exterior glass piece 42, as shown in FIG. 2, or the outer surface 54 of the interior glass piece 44. As discussed hereinbelow, the IG unit 40 having the coating 12 of the invention provides a visible light transmittance of greater than about 50%, preferably 55%; a shading coefficient of less than about 0.33; and an exterior reflectance of less than about 30% when normally positioned, e.g. the outer surfaces directed to the exterior of the structure and the inner surfaces directed to the interior of the structure.

### EXAMPLES

Coatings were prepared in accordance with the invention and analyzed for optical qualities. The coating layers were deposited at the specified thickness as shown in Table I on pieces of clear float glass of the thickness shown in Table I by MSVD for an IG unit. In the IG unit the coated glass was as reference number 44 and the coating as reference number 54 in FIG. 2. The structure of the coated samples is given in Table I, with the layer thickness given in Angstroms. In each sample, the first, second and third antireflective layers (AR layers) were multifilm zinc oxide and zinc stannate structures as described above. The numbers in Table I are for the total thickness of the specific layers, with each individual zinc oxide film in an AR layer being about 50 to 60 Angstroms thick. The first and second IR reflective layers (IR layers) were silver and the primer layers were titanium. The overcoat was titanium dioxide. The notation ND means that no data was taken.

TABLE I

| | Glass | | | | | | | | |
|---|---|---|---|---|---|---|---|---|---|
| | thick- | | | | | | | | |
| Sample | ness | 1^{st} | | | 2^{nd} | 2^{nd} | | 3^{rd} | Over- |
| No. | inch | AR | Ag | Ti | AR | Ag | Ti | AR | coat |
| 1 | 0.1596 | 332 | 128 | 15 | 771 | 246 | 15 | 168 | 45 |
| 2 | 0.0862 | 312 | 236 | 15 | 698 | 159 | 15 | 202 | 45 |
| 3 | 0.0863 | 272 | 236 | 15 | 845 | 192 | 15 | 196 | 45 |
| 4 | 0.0863 | 313 | 246 | 15 | 863 | 210 | 15 | 250 | 45 |
| 5 | 0.126 | 300 | 86 | 13 | 714 | 175 | 13 | 123 | 30 |
| 6 | 0.126 | 300 | 86 | 13 | 714 | 175 | 13 | 60 | 30 |
| 7 | 0.125 | 300 | 95 | 13 | 734 | 184 | 13 | 98 | 30 |
| 8 | 0.126 | 300 | 103 | 13 | 808 | 202 | 13 | 194 | 30 |
| 9 | 0.126 | 300 | 107 | 13 | 734 | 167 | 13 | 98 | 30 |
| 10 | 0.126 | 300 | 103 | 13 | 714 | 184 | 13 | 98 | 30 |
| 11 | 0.124 | 293 | 80 | 17 | 719 | 178 | 15.5 | 105 | 43 |
| 12 | 0.123 | 293 | 86 | 17 | 695 | 178 | 15.5 | 105 | 43 |
| 13 | 0.125 | 293 | 86 | 17 | 719 | 178 | 15.5 | 115 | 43 |

The optical and performance characteristics of the samples of Table I are shown in Table II. The optical characteristics in Table II are calculated values (“center of glass”) for either a monolithic piece of glass or an IG unit incorporating the respective sample coatings. These calculations used the spectrophotometric data and the “WINDOW” 4.1 simulation software program available from Lawrence Berkeley National Laboratory. All of the optical characteristics in Table II, with the exception of LCS, are standard and well known terms in the glass industry. The term “LCS” refers to a light to cooling selectivity index and is defined as the percent visible light transmittance (expressed as a decimal) divided by the shading coefficient.

TABLE II

| | | % ext vis | % int vis | Summer shading | Solar heat gain | | | | Winter |
|---|---|---|---|---|---|---|---|---|---|
| Sample No. | % vis | reflectance | reflectance | coefficient | coefficient | LCS | LHS | Emissivity | U-value |
| 1 | 55.2 | 21.8 | 29.2 | 0.29 | 0.25 | 1.90 | 2.21 | 0.03 | 0.24 |
| 2 | 56.8 | 25.3 | 20.4 | 0.29 | 0.25 | 1.96 | 2.27 | 0.029 | 0.29 |
| 3 | 57.2 | 25.7 | 24.5 | 0.29 | 0.25 | 1.97 | 2.29 | 0.041 | 0.30 |
| 4 | 58.9 | 23.8 | 22.3 | 0.29 | 0.25 | 2.03 | 2.36 | 0.039 | 0.30 |
| 5 | 56.7 | 21.9 | 29.1 | 0.33 | 0.28 | 1.72 | 2.03 | 0.032 | 0.29 |
| 6 | 51.2 | 26.3 | 35.5 | 0.30 | 0.25 | 1.71 | 2.05 | 0.032 | 0.29 |
| 7 | 53.1 | 24.7 | 33 | 0.30 | 0.26 | 1.77 | 2.04 | 0.033 | 0.29 |
| 8 | 54.1 | 25.5 | 31.8 | 0.30 | 0.26 | 1.80 | 2.08 | 0.029 | 0.29 |
| 9 | 58.6 | 19.8 | 26.6 | 0.32 | 0.28 | 1.83 | 2.09 | 0.031 | 0.29 |
| 10 | 53.2 | 22.2 | 31.6 | 0.29 | 0.25 | 1.83 | 2.13 | 0.029 | 0.29 |
| 11 | 54.3 | 25.1 | 32.5 | 0.32 | 0.27 | 1.70 | 2.01 | 0.029 | 0.29 |
| 12 | 55.0 | 23.4 | 31.4 | 0.31 | 0.27 | 1.77 | 2.04 | 0.048 | 0.30 |
| 13 | 56.0 | 23.5 | 30.6 | 0.32 | 0.28 | 1.75 | 2.00 | 0.048 | 0.30 |

Table III shows several listed physical parameters for monolithic glass samples coated with coating of Table I and listed performance data for these glasses.

TABLE III
Monolithic Performance Data (all data are center-of-glass)

| | | | | | | | | | solar heat | | | |
|---|---|---|---|---|---|---|---|---|---|---|---|---|
| | | | | | | | | summer shading | gain coef- | | | |
| | clear | | glass-side | coating-side | | | | coefficient | ficient | | | coated |
| | glass | visible | visible | visible | | TSER- | TSER- | (energy | (energy inci- | | | surface |
| Sample | thickness | transmit- | reflectance | reflectance | TSET | glass- | coating- | incident on | dent on coat- | | | emis- |
| ID | (inch) | tance (%) | (%) | (%) | (%) | side (%) | side (%) | coated surface) | ed surface) | LCS | LHS | sivity |
| 1 | 0.1596 | 60.3 | 18.6 | 25.3 | 28.2 | 37.9 | 60.7 | 0.38 | | | | 0.030 |
| 2 | 0.0862 | 62.1 | 21.9 | 14.2 | 25.3 | 51.3 | 59.2 | 0.35 | 0.30 | 1.77 | 2.07 | 0.029 |
| 3 | 0.0863 | 62.3 | 22.3 | 18.9 | 25.1 | 51.3 | 60.2 | 0.35 | 0.30 | 1.78 | 2.08 | 0.041 |
| 4 | 0.0863 | 64.2 | 20.2 | 16.4 | 24.8 | 51.7 | 60.7 | 0.34 | 0.30 | 1.89 | 2.14 | 0.039 |
| 5 | 0.126 | 61.8 | 18.6 | 25.0 | 27.5 | 40.0 | 61.5 | 0.36 | 0.31 | 1.72 | 1.99 | 0.032 |
| 6 | 0.126 | 55.4 | 23.5 | 32.5 | 24.6 | 42.3 | 65.4 | 0.32 | 0.28 | 1.73 | 1.98 | 0.032 |
| 7 | 0.125 | 57.6 | 21.8 | 29.6 | 24.7 | 42.7 | 65.0 | 0.33 | 0.28 | 1.75 | 2.06 | 0.033 |
| 8 | 0.126 | 58.8 | 22.5 | 28.1 | 25.1 | 42.4 | 61.1 | 0.33 | 0.29 | 1.78 | 2.03 | 0.029 |
| 9 | 0.126 | 64.0 | 16.2 | 21.9 | 27.1 | 40.6 | 61.6 | 0.36 | 0.31 | 1.78 | 2.06 | 0.031 |
| 10 | 0.126 | 57.8 | 19.2 | 27.9 | 23.8 | 43.4 | 65.8 | 0.32 | 0.27 | 1.81 | 2.14 | 0.029 |
| 11 | 0.124 | 58.9 | 22.0 | 29.0 | 26.8 | 40.9 | 62.8 | 0.35 | 0.30 | 1.68 | 1.96 | 0.029 |
| 12 | 0.123 | 59.7 | 20.3 | 27.7 | 26.4 | 41.4 | 63.2 | 0.35 | 0.30 | 1.71 | 1.99 | 0.048 |
| 13 | 0.125 | 60.9 | 20.3 | 26.8 | 27.2 | 40.9 | 62.3 | 0.35 | 0.31 | 1.74 | 1.96 | 0.048 |

The results of mechanical and chemical durability tests conducted on the samples are shown in Table IV.

TABLE IV

| Sample | Initial | Salt | Ammonium | Acetic | DART | | Taber |
|---|---|---|---|---|---|---|---|
| No. | Haze | Test | Test | Acid | 210 | CCC | Test |
| 1 | ND | ND | ND | ND | ND | ND | ND |
| 2 | ND | ND | ND | ND | ND | ND | ND |
| 3 | ND | ND | ND | ND | ND | ND | ND |
| 4 | ND | ND | ND | ND | ND | ND | ND |
| 5 | 12.0 | 9.0 | 10.0 | 9.0 | 9.5 | 8.5 | 65 |
| 6 | 11.0 | 8.5 | 9.0 | 8.5 | 9.0 | 7.0 | ND |
| 7 | 11.0 | 9.0 | 9.5 | 9.5 | 9.0 | 9.0 | 62 |
| 8 | 11.0 | 9.0 | 9.0 | 9.5 | 9.0 | 8.5 | ND |
| 9 | 11.0 | 9.0 | 9.0 | 9.5 | 8.5 | 9.0 | 63 |
| 10 | 11.0 | 8.5 | 9.0 | 8.0 | 8.5 | 6.0 | ND |
| 11 | 9.0 | 9.0 | 9.0 | 9.5 | 9.0 | 9.0 | 58 |
| 12 | 9.5 | 9.0 | 9.0 | 9.0 | 9.5 | 9.0 | 56 |
| 13 | 9.3 | 9.0 | 9.3 | 9.5 | 9.0 | 9.3 | 63 |

The haze ratings shown in Table IV are based on a twelve unit system, with twelve being substantially haze free and lower numbers indicating increasing levels of haze. In the following discussion unless indicated to the contrary, the observation for haze was performed as follows. A coated piece of glass (“coupon”) was treated in accordance with the particular test being conducted. The coupons were individually observed with the unaided eye in a dark room with about 150 watt flood light. The coupon was placed in front of the light, and its position was adjusted relative to the light to maximize haze. The observed haze was then rated.

The salt water test consists of placing the coated glass pieces or coupons in a 2.5 weight percent (wt %) solution of sodium chloride in deionized water for 2.5 hours. The coupons were removed, rinsed in deionized water and dried with pressurized nitrogen and then rated for haze.

In the ammonium hydroxide test a test coupon was placed in a 1 Normal solution of ammonium hydroxide in deionized water at room temperature for 10 minutes. The coupon was removed from the solution, rinsed in deionized water and dried as discussed above. The test coupon was examined for haze.

In the acetic acid test a test coupon was submerged in a 1 normal solution of acetic acid in deionized water at room temperature for 10 minutes. The test coupon was removed from the solution and rinsed off with deionized water and blown dry using high pressure nitrogen. The test coupon was examined for haze.

The Cleveland Condensation Chamber (CCC) test is a well-known test and is not discussed in detail herein. The test coupons were exposed to the CCC test for a period of time with warm water vapor and examined for haze. The abbreviation “ND” stands for “no data”.

The Taber test is also a well known test and will not be described in detail. Generally the modified Taber test comprises securing the sample to be tested on a flat, circular turntable. Two circular, rotating Calibrase® CS-10F abrasive wheels (commercially available from Taber Industries of N. Tonawanda, N.Y.) are lowered onto the top surface of the sample to be tested; there is a load of 500 grams applied to each abrasive wheel. The Calibrase® CS-10F wheels are an elastomeric-type material that is impregnated with an abrasive. To conduct the test, the turntable is switched “ON” and the abrasive wheels turn and abrade the sample's surface as the sample and turntable rotate about a vertical axis until the desired number of rotations or “cycles”, here 10, is completed. After testing, the sample is removed from the turntable and examined for damage to the top surface. The numbers in Table IV denote the scratch density per square millimeter for a black and white micrograph at a 50× magnification.

Thus, the present invention provides a low emissivity, solar control article, e.g. an IG unit, having visible light transmission of greater than about 50%, a shading coefficient less than about 0.33 and an exterior reflectance less than about 30%. Such an article is particularly well adapted for use in warmer climates to help reduce cooling costs for the interior of a structure.

In a preferred embodiment, a solar control coated article of the invention comprises a substrate with a first antireflective layer deposited over at least a portion of the substrate. A first infrared reflective film is deposited over the first antireflective layer and a first primer film is deposited over the first infrared reflective film. A second antireflective layer is deposited over the first primer film and a second infrared reflective film is deposited over the second antireflective layer. A second primer film is deposited over the second infrared reflective film and a third antireflective layer is deposited over the second primer film, such that the coated article has a transmittance greater than about 55%, a shading coefficient of less than about 0.33 and a reflectance of less than about 30%. A protective overcoat, e.g. an oxide or oxynitride of titanium or silicon, may be deposited over the third antireflective film.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the above disclosure and any and all equivalents thereof.

1-38. (canceled)

39. A solar control article, comprising:
a first substrate spaced from a second substrate; and
a solar control coating formed over at least a portion of the first or second substrate, the solar control coating comprising:
a first antireflective layer having a thickness in the range of 272 Å to 332 Å and comprising a zinc stannate layer and a zinc oxide layer, with the zinc oxide layer having a thickness in the range of 20 Å to 70 Å;
a first metallic layer comprising silver and having a thickness in the range of 80 Å to 269 Å;
a second antireflective layer having a thickness in the range of 698 Å to 863 Å and comprising a zinc stannate layer located between two zinc oxide layers, with each zinc oxide layer having a thickness in the range of 20 Å to 70 Å;
a second metallic layer comprising silver and having a thickness in the range of 159 Å to 257 Å; and
a third antireflective layer having a thickness in the range of 60 Å to 273 Å and comprising a zinc oxide layer and a zinc stannate layer, with the zinc oxide layer having a thickness in the range of 20 Å to 70 Å,
wherein the article has a shading coefficient of less than 0.33, a visible light transmittance in the range of 50% to 70%, and a visible light reflectance of less than 30%.

40. The article as claimed in claim 39, wherein the substrates are selected from the group consisting of glass, plastic and ceramic.

41. The article as claimed in claim 39, wherein the article is an insulated glass unit.

42. The article as claimed in claim 39, including a protective overcoat deposited over the third antireflective layer.

43. The article as claimed in claim 42, wherein the overcoat comprises titania having a thickness in the range of 30 Å to 45 Å.

44. The article as claimed in claim 39, wherein the first substrate comprises clear glass and the second substrate is selected from the group consisting of tinted glass and colored glass.

45. The article as claimed in claim 39, wherein the article has an emissivity of less than 0.04.

46. The article as claimed in claim 39, wherein the coating has a haze rating of greater than 9.

47. A solar control coated article, comprising:
a transparent substrate having a surface;
a coating over the surface to provide a coated article having a visible light transmittance in the range of 50 to 70%, a shading coefficient less than 0.33 and a reflectance less than 30%, the coating comprising:
a first antireflective layer over a substrate surface, wherein the first antireflective layer has a thickness of 272 to 332 angstroms;
a first infrared reflective layer over the first antireflective layer, wherein the first infrared reflective layer has a thickness of 86 to 269 angstroms;
a first primer layer deposited over the first infrared reflective layer, wherein the primer layer has a thickness of 15 to 30 angstroms;
a second antireflective layer deposited over the first primer layer, wherein the second antireflective layer has a thickness of 198 to 836 angstroms;
a second infrared reflective layer deposited over the second antireflective layer, wherein the second infrared reflective layer has a thickness of 159 to 257 angstroms;
a second primer film deposited over the second infrared reflective layer, wherein the primer layer has a thickness of 15 to 30 angstroms; and
a third antireflective layer deposited over the second primer layer, wherein the third antireflective layer has a thickness of 60 to 273 angstroms.

48. The article as claimed in claim 47, wherein the article has a substantially neutral color.

49. The article as claimed in claim 47, wherein the article has a shading coefficient of less than 0.32 and an external reflectance less than 20%.

50. The article as claimed in claim 47, wherein the antireflective films include a metal oxide film selected from the group consisting of metal oxides, metal alloys, doped metal oxides and mixtures thereof.

51. The article as claimed in claim 50, wherein in the metal oxides are selected from the group consisting of zinc oxide, titanium oxide, hafnium oxide, zirconium oxide, niobium oxide, bismuth oxide, indium oxide, tin oxide and mixtures thereof.

52. The article as claimed in claim 50, wherein the metal alloys are selected from the group consisting of zinc stannate, fluorine doped tin, antimony doped tin, and indium-tin alloys.

53. The article as claimed in claim 50, wherein the doped metal oxides are selected from the group consisting of antimony doped tin oxide and indium doped tin oxide.

54. The article as claimed in claim 47, wherein the first infrared reflective layer includes a metal from the group consisting of gold, copper, platinum, and silver and mixtures thereof.

55. The article as claimed in claim 47, where at least one of the first, second, or third antireflective layers includes a plurality of antireflective films.

56. The article as claimed in claim 47, wherein the primer layer includes titanium.

57. The article as claimed in claim 47, including a protective, metal containing overcoat deposited over the third antireflective layer.

58. A method of making a solar control article, comprising the steps of:
providing a substrate having a surface;
depositing a coating over at least a portion of the surface of the substrate to provide a coated article having a visible light transmittance in the range of 50 to 70%, a shading coefficient less than 0.33 and a reflectance less than 30%, the depositing step comprising the steps of:
depositing a first antireflective layer over at least a portion of a substrate surface;
depositing a first infrared reflective layer over at least a portion of the first antireflective layer;
depositing a second antireflective layer deposited over at least a portion of the first infrared reflective layer;
depositing a second infrared reflective layer deposited over at least a portion of the second antireflective layer, wherein the second infrared reflective layer has a thickness of 159 to 257 angstroms; and
depositing a third antireflective layer having a thickness ranging from 60 to 273 angstroms over the second infrared reflective layer.
